(19) United States
(12) Patent Application Publication
(10) Pub. No.: US 2025/0023129 A1
(43) Pub. Date: Jan. 16, 2025

(54) SMART BATTERY BALANCING FOR REDUCED ENERGY LOSS

(71) Applicant: LENOVO (SINGAPORE) PTE. LTD., SINGAPORE (SG)

(72) Inventors: Bouziane Yebka, Morrisville, NC (US); Tin-Lup Wong, Morrisville, NC (US); Philip J Jakes, Morrisville, NC (US)

(21) Appl. No.: 18/351,475

(22) Filed: Jul. 12, 2023

(51) Int. Cl. H01M 10/44; H01M 10/42; H02J 7/00

(52) U.S. Cl. CPC H01M 10/441; H01M 10/4257; H02J 7/0016; H01M 2010/4271

(57) ABSTRACT

In one aspect, a device includes a processor assembly and storage accessible to the processor assembly. The storage includes instructions executable by the processor assembly to determine that a first battery cell of a battery pack has a higher voltage than a second battery cell of the battery pack and, based on the determination, use system load to discharge the first battery cell more than the second battery cell. For instance, based on the determination, system load may be used to discharge the first battery cell while the second battery cell is not discharged at all with system load or other power draws external to the second battery cell.

### FIELD

The disclosure below relates to technically inventive, non-routine solutions that are necessarily rooted in computer technology and produce concrete technical improvements. In particular, the disclosure below relates to smart battery balancing for reduced energy loss.

### BACKGROUND

As recognized herein, balancing the voltage level of different battery cells in a battery pack is helpful to improve the performance of the pack, extend the pack's life, and make the pack safer. The cells themselves might become out of balance in the first place since cells do not all age the same way, even if manufactured the same with the same specifications. As such, voltages and charge maximums of each cell may start to diverge over time. However, as also recognized herein, current cell balancing techniques lead to unacceptable energy loss, whether that balancing is active or passive. Indeed, often times this energy loss is quite significant.

Additionally and as also recognized herein, current active and passive cell balancing techniques also result in unnecessary heat generation within the battery pack, which can then adversely affect the performance and health of other components of the larger device in which the battery pack is disposed when the heat is transferred to those components. And while this unnecessary heat generation can be managed with active cooling through system fans and other means, this compounds the energy loss since more energy is consumed for cooling.

There are currently no adequate solutions to the foregoing technological problems.

### SUMMARY

Accordingly, in one aspect, a device includes a processor assembly and storage accessible to the processor assembly. The storage includes instructions executable by the processor assembly to determine that a first battery cell of a battery pack has a higher voltage than a second battery cell of the battery pack and, based on the determination, use system load to discharge the first battery cell more than the second battery cell.

Thus, in one example implementation the instructions may be executable to, based on the determination, use system load to discharge the first battery cell more than the second battery cell and, concurrent with using system load to discharge the first battery cell more than the second battery cell, not discharge the second battery cell.

As another example implementation, the instructions may be executable to, based on the determination, use system load to discharge the first battery cell more than the second battery cell and, concurrent with using system load to discharge the first battery cell more than the second battery cell, neither discharge nor charge the second battery cell.

As yet another example implementation, the instructions may be executable to, based on the determination, use system load to discharge the first battery cell more than the second battery cell and, concurrent with using system load to discharge the first battery cell more than the second battery cell, not use any system load to discharge the second battery cell. So, for example, the instructions may be executable to, based on the determination, use system load to discharge the first battery cell more than the second battery cell and, concurrent with using system load to discharge the first battery cell more than the second battery cell, neither use any system load to discharge the second battery cell nor charge the second battery cell. Additionally or alternatively, the instructions may be executable to, based on the determination, use system load to discharge the first battery cell more than the second battery cell and, concurrent with using system load to discharge the first battery cell more than the second battery cell, not use any system load to discharge the second battery cell but charge the second battery cell (e.g., incrementally charge the second battery cell by increasingly greater amounts). Still further, if desired and based on the determination, the instructions may be executable to use system load to discharge the first battery cell more than the second battery cell and to incrementally charge both the first battery cell and the second battery cell.

In certain example embodiments, the processor may be established by a gas gauge. The gas gauge may be located/disposed, e.g., within the battery pack. The device may even include the battery pack itself, and in certain non-limiting embodiments the first battery cell may be a good battery cell and the second battery cell may be a weak battery cell.

In another aspect, a method includes determining that a first battery cell of a battery pack has a higher voltage than a second battery cell of the battery pack and, based on the determination, using system load to discharge the first battery cell more than the second battery cell.

Thus, in one example implementation the method may include, based on the determination, using system load to discharge the first battery cell more than the second battery cell and, concurrent with using system load to discharge the first battery cell more than the second battery cell, neither using any system load to discharge the second battery cell nor charging the second battery cell.

As another example implementation, the method may include, based on the determination, using system load to discharge the first battery cell more than the second battery cell and, concurrent with using system load to discharge the first battery cell more than the second battery cell, not using any system load to discharge the second battery cell but charging the second battery cell (e.g., incrementally charging the second battery cell by increasingly greater amounts).

As yet another example implementation, based on the determination, the method may include using system load to discharge the first battery cell more than the second battery cell and incrementally charging both the first battery cell and the second battery cell.

In still another aspect, at least one computer-readable storage medium (CRSM) that is not a transitory signal includes instructions executable by a processor assembly to determine that a first battery cell of a battery pack has a different voltage than a second battery cell of the battery pack and, based on the determination, use system load to discharge the first battery cell more than the second battery cell.

In one example implementation, the instructions may be executable to, based on the determination, use system load to discharge the first battery cell more than the second battery cell and, concurrent with using system load to discharge the first battery cell more than the second battery cell, neither use any system load to discharge the second battery cell nor charge the second battery cell.

In another example implementation, the instructions may be executable to, based on the determination, use system load to discharge the first battery cell more than the second battery cell and, concurrent with using system load to discharge the first battery cell more than the second battery cell, not use any system load to discharge the second battery cell but charge the second battery cell.

In still another example implementation, based on the determination the instructions may be executable to use system load to discharge the first battery cell more than the second battery cell and incrementally charge both the first battery cell and the second battery cell until a maximum current charge potential of the second battery cell is identified. Responsive to identifying the maximum current charge potential of the second battery cell, the instructions may be further executable to subsequently charge both the first and second battery cells to the maximum current charge potential but not beyond the maximum current charge potential.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 is an example circuit diagram of a battery pack that may be used consistent with present principles;

FIGS. 3-5 show respective graphs of voltages of good and weak cells over time using three respective example implementations of present principles; and

FIG. 6 illustrates example logic in example flow chart format that may be executed by a gas gauge processor or other processor consistent with present principles.

### DETAILED DESCRIPTION

Present principles are related to an improved battery pack that conserves power and wastes less energy while also minimizing unnecessary heat generation that can adversely affect computer hardware components. Specifically, present principles are at least in part directed to limiting the dominance of the pack's weakest cell in cell balancing, with power from the highest-voltage cell(s) being used productively.

Note with respect to any computer systems discussed herein that a system may include server and client components connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smartphones These client devices may employ, as non-limiting examples, operating systems from Apple Inc. of Cupertino CA, Google Inc. of Mountain View, CA, or Microsoft Corp. of Redmond, WA. A Unix® or similar such as Linux® operating system may be used, as may a Chrome or Android or Windows or macOS operating system. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any single- or multi-chip processor that can execute logic by means of various lines such as address lines, data lines, and control lines and registers and shift registers. Moreover, any logical blocks, modules, and circuits described herein can be implemented or performed with a system processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can also be implemented by a controller or state machine or a combination of computing devices. Thus, the methods herein may be implemented as software instructions executed by a processor, suitably configured application specific integrated circuits (ASIC) or field programmable gate array (FPGA) modules, or any other convenient manner as would be appreciated by those skilled in those art. Where employed, the software instructions may also be embodied in a non-transitory device that is being vended and/or provided, and that is not a transitory, propagating signal and/or a signal per se. For instance, the non-transitory device may be or include a hard disk drive, solid-state drive, or CD ROM. Flash drives may also be used for storing the instructions. Additionally, the software code instructions may also be downloaded over the Internet (e.g., as part of an application (“app”) or software file). Accordingly, it is to be understood that although a software application for undertaking present principles may be vended with a device such as the system 100 described below, such an application may also be downloaded from a server to a device over a network such as the Internet. An application can also run on a server and associated presentations may be displayed through a browser (and/or through a dedicated companion app) on a client device in communication with the server.

Software modules and/or applications described by way of flow charts and/or user interfaces herein can include various sub-routines, procedures, etc. Without limiting the disclosure, logic stated to be executed by a particular module can be redistributed to other software modules and/or combined together in a single module and/or made available in a shareable library. Also, the user interfaces (UI)/graphical UIs described herein may be consolidated and/or expanded, and UI elements may be mixed and matched between UIs.

Logic when implemented in software, can be written in an appropriate language such as but not limited to hypertext markup language (HTML)-5, Java®/JavaScript, C# or C++, and can be stored on or transmitted from a computer-readable storage medium such as a hard disk drive (HDD) or solid-state drive (SSD), a random access memory (RAM), read-only memory (ROM), electrically erasable programmable read-only memory (EEPROM), a hard disk drive or solid-state drive, compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term “circuit” or “circuitry” may be used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as processors (e.g., special-purpose processors) programmed with instructions to perform those functions.

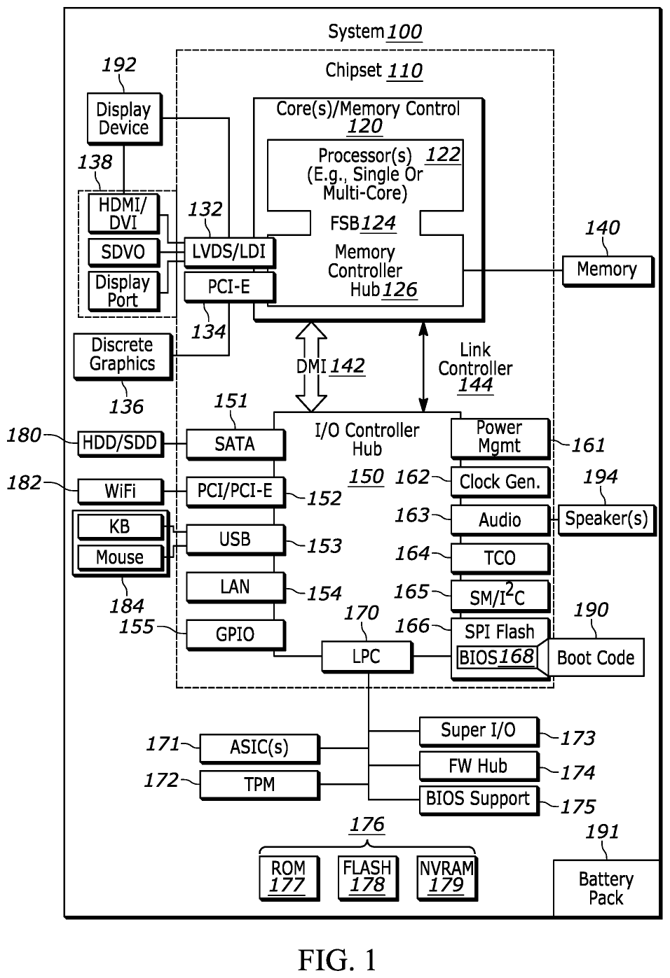

Now specifically in reference to FIG. 1, an example block diagram of an information handling system and/or computer system 100 is shown that is understood to have a housing for the components described below. Note that in some embodiments the system 100 may be a desktop computer system, such as one of the ThinkCentre® or ThinkPad® series of personal computers sold by Lenovo (US) Inc. of Morrisville, NC, or a workstation computer, such as the ThinkStation®, which are sold by Lenovo (US) Inc. of Morrisville, NC; however, as apparent from the description herein, a client device, a server or other machine in accordance with present principles may include other features or only some of the features of the system 100. Also, the system 100 may be, e.g., a game console such as XBOX®, and/or the system 100 may include a mobile communication device such as a mobile telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 includes a processor assembly 122 (e.g., one or more single core or multi-core processors, etc.) and a memory controller hub 126 that exchange information via a front side bus (FSB) 124. A processor assembly such as the assembly 122 may therefore include one or more processors acting independently or in concert with each other to execute an algorithm, whether those processors are in one device or more than one device. Additionally, as described herein, various components of the core and memory control group 120 may be integrated onto a single processor die, for example, to make a chip that supplants the “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled light emitting diode (LED) display or other video display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (x16) PCI-E port for an external PCI-E-based graphics card (including, e.g., one or more GPUs). An example system may include AGP or PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more universal serial bus (USB) interfaces 153, a local area network (LAN) interface 154 (more generally a network interface for communication over at least one network such as the Internet, a WAN, a LAN, a Bluetooth network using Bluetooth 5.0 communication, etc. under the direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes basic input/output system (BIOS) 168 and boot code 190. With respect to network connections, the I/O hub controller 150 may include integrated gigabit Ethernet controller lines multiplexed with a PCI-E interface port. Other network features may operate independent of a PCI-E interface. Example network connections include Wi-Fi as well as wide-area networks (WANs) such as 4G and 5G cellular networks.

The interfaces of the I/O hub controller 150 may provide for communication with various devices, networks, etc. For example, where used, the SATA interface 151 and/or PCI-E interface 152 provide for reading, writing or reading and writing information on one or more drives 180 such as HDDs, SSDs or a combination thereof, but in any case the drives 180 are understood to be, e.g., tangible computer readable storage mediums that are not transitory, propagating signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

Furthermore, the system 100 may also include at least one battery/pack 191 that includes plural battery cells. Each battery cell may include an anode, a cathode, and an electrolyte between the anode and the cathode. The cells may be in jelly roll format. The cells may also be configured in pouch cell format in which the strip(s) of active materials are folded, or in a stacked format if desired. Regardless, the battery cells may be Lithium-ion battery cells, alkaline-based battery cells, acid-based battery cells, and/or other types of battery cells.

It is to be further understood consistent with present principles that the battery pack 191 may be electrically coupled to and power the system 100, and/or individual components thereof, using battery power. The system 100, and/or battery pack 191 in particular, may also be electrically coupled to at least one charge receiver on the system 100 for receiving a charge via an AC/DC power supply connected to an AC power source (e.g., a wall outlet providing AC power) to charge the battery cells in the pack 191. Thus, the charge receiver may include at least one circuit configured for receiving power from a wall outlet (or other AC power source) via the power supply and then providing power to the system 100 to power it and also charge the cells within the battery 191. In some examples, wireless charging using a wireless charge receiver and wireless charge transmitting pad may be used.

In addition to containing plural battery cells, the battery pack 191 may include its own one or more processors, such as a microprocessor or any other type of processor that might be provided as part of a gas gauge or battery management unit (BMU) within the battery pack 191. Non-transitory storage may also be included in the battery pack 191, with the storage storing firmware or other executable instructions consistent with the disclosure below. Random access memory (RAM) and other components may also be included in the battery pack 191, such as one or more sensors for sensing/measuring things related to the battery pack 191 and/or cells within. For instance, the pack 191 may include sensors to sense temperature, voltage, electric potential, age, impedance, state of charge, etc. These sensors may therefore provide input/measurements to the processor(s) within the battery pack 191 and/or the processor(s) 122 external to the battery pack 191 consistent with present principles (e.g., to determine that a first battery cell of the battery pack 191 has a higher voltage than a second battery cell of the battery pack 191).

However, it is to be understood that a battery pack consistent with present principles need not necessarily be a smart battery pack with a processor internal to the pack, but may instead be established by one or more battery cells without a processor, storage, other computing components, etc. If so, the CPU, a DSP, or another processor external to the battery pack 191 but still internal to the system 100, or even a processor external to the system 100 but still communicatively coupled to the system 100 (e.g., via the Internet), may be used to control the circuit within the pack 191 for smart cell balancing consistent with the disclosure below.

Additionally, though not shown for simplicity, in some embodiments the system 100 may further include a gyroscope that senses and/or measures the orientation of the system 100 and provides related input to the processor 122, an accelerometer that senses acceleration and/or movement of the system 100 and provides related input to the processor 122, and/or a magnetometer that senses and/or measures the directional movement of the system 100 and provides related input to the processor 122.

Still further, the system 100 may include an audio receiver/microphone that provides input from the microphone to the processor 122 based on audio that is detected, such as via a user providing audible input to the microphone. The system 100 may also include a camera that gathers one or more images and provides the images and related input to the processor 122. The camera may be a thermal imaging camera, an infrared (IR) camera, a digital camera such as a webcam, a three-dimensional (3D) camera, and/or a camera otherwise integrated into the system 100 and controllable by the processor 122 to gather still images and/or video.

Also, the system 100 may include a global positioning system (GPS) transceiver that is configured to communicate with satellites to receive/identify geographic position information and provide the geographic position information to the processor 122. However, it is to be understood that another suitable position receiver other than a GPS receiver may be used in accordance with present principles to determine the location of the system 100.

It is to be understood that an example client device or other machine/computer may include fewer or more features than shown on the system 100 of FIG. 1. In any case, it is to be understood, at least based on the foregoing, that the system 100 is configured to undertake present principles.

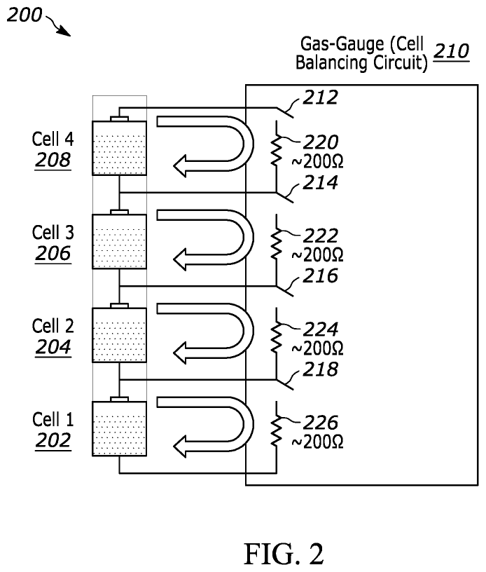

Now referring to FIG. 2, it shows an example circuit diagram for a battery pack (such as the pack 191) consistent with present principles. The diagram, therefore, shows a circuit 200 that can be used both for cell balancing consistent with present principles as well as to power a computer, smartphone, etc. in which it is housed using power from the cells managed by the circuit 200. Accordingly, as shown in FIG. 2, the circuit 200 may include a first battery cell 202, a second battery cell 204, a third battery cell 206, and a fourth battery cell 208. As also shown in this example, the cells 202-208 are connected in series. The cells 202-208 may be Lithium-ion battery cells or another type of battery cell including those mentioned above.

As also shown in FIG. 2, the circuit 200 may include a gas gauge and/or battery management unit 210 establishing at least part of a cell balancing circuit/sub-circuit. The gas gauge 210 may have its own processor and storage with instructions executable by the processor to perform cell balancing and charging functions as described herein. For example, the processor in the gas gauge 210 may execute firmware to monitor and identify the current state of charge/voltage of the battery cells 202-208, as well as to control the switches 212-218 to open and close for cell balancing, charging, and powering the larger system (e.g., computer). Thus, the processor may execute firmware to open and close the switches 212-218 to selectively use power from one or more of the cells (but not all cells) to power the system 100 of FIG. 1, using system load to discharge power from those cells. The switches 212-218 may be electrical switches and/or field-effect transistors such as metal-oxide-semiconductor field-effect transistors (MOSFETs). Furthermore, note that while the switches 212-218 are shown as being located within the gas gauge 210, in some examples they may be located in other parts of the battery pack outside of the gauge 210.

Resistors 220, 222, 224, and 226 may also be included in the circuit 200 and between the switches 212-218. The resistors 220-226 may be 200-ohm resistors in certain examples, though resistors of other amounts of resistance may also be used. Also note that as with the switches 212-218, even though the resistors 220-226 are shown as being located within the gas gauge 210, in other examples they may be located in other parts of the battery pack outside of the gauge 210.

Thus, as mentioned above, during smart cell balancing consistent with present principles, the switches 212-218 may be selectively opened and closed by the gas gauge processor to power computing components of a laptop, desktop computer, smartphone, wearable device, headset, or other device type in which the battery pack is disposed using one or more of the cells 202-208, while selectively not using power from at least one other cell 202-208 to power the device's components, thereby bringing the voltage of the cells put into use down to the voltage level of the cell(s) not put into use so that all cells are ultimately equalized and/or balanced. For this, only one switch 220-226 may be turned on at a given time for voltage from the highest-voltage cell 202-208 to power the system components, or more than one switch may be turned on concurrently and then each switch turned off at different times once the respective cell for that switch reaches the voltage level of the lowest-voltage cell. Example current flow is also illustrated via the arrows shown in FIG. 2, though this flow may vary based on which switches 212-218 are turned on to power the system components and which are turned off to not power the system components. Also note that additional switches as well as electrical bypass lines may also be included to isolate one or more cells so that power can be provided from those cells to the system components while power is not provided by other cells, depending on implementation.

Before moving on to other figures, also note that although four cells are shown in the example of FIG. 2, more or less cells may also be included in a battery pack consistent with present principles.

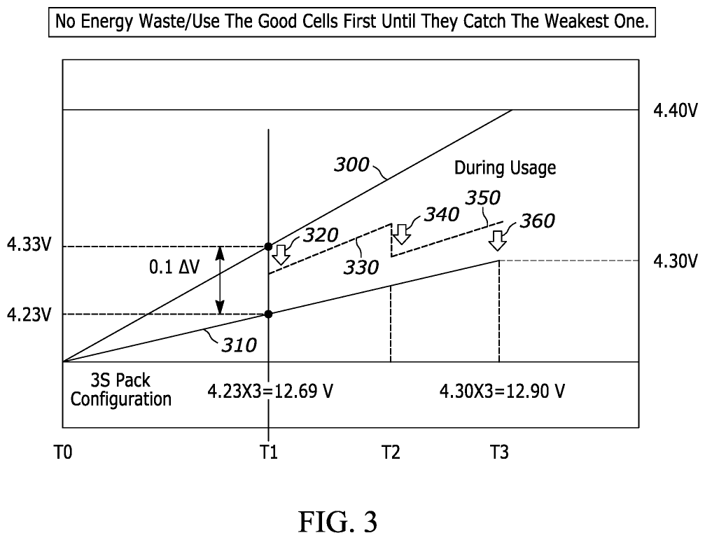

FIGS. 3-5 illustrate different example implementations consistent with present principles by way of graphs that show time increasing from left to right along the X axis and voltage increasing from bottom to top along the Y axis. Also note that for each example implementation, system load is being used to discharge a first battery cell more than a second cell to reduce voltage in the first battery cell and balance it with the voltage level of the second battery cell so that their voltages are equal or at least equal to within a threshold. In non-limiting examples, system load may be power draw from components of the larger device in which the battery pack is disposed that consume power from the battery pack, including any of the system components described above in reference to the system 100 (e.g., save for those described specifically in reference to the pack 191 itself).

Now referring to FIG. 3 specifically, one example implementation consistent with present principles is shown. According to this implementation, a “good” first cell is discharged using system load while a “weak” second cell that has degraded or is unhealthy is not charged or discharged. This helps ensure no undue energy waste since the “good” cell(s) are used first until they catch the weakest cell in the pack in terms of voltage.

As also shown in FIG. 3, line 300 indicates increased voltage that may be experienced from time T0 to time T3 by the first cell due to cell relaxation if the first cell is not used during that time span (e.g. not charged or not discharged at all), while line 310 indicates increased voltage that may be experienced from time T0 to time T3 by the second cell due to cell relaxation if the second cell is not used during that time span. Cell relaxation may involve, in non-limiting implementations, diffusion of ions from an external surface (e.g., terminal) of a cell, where they might have accumulated during a charge or discharge cycle, following the charge or discharge cycle itself. The ions may thus diffuse back into the battery cell itself, increasing its voltage. It is to also be understood that the higher the rate of charge or discharge, the greater the potential accumulation of ions on the external surface and the more this effect will manifest itself. Therefore, the amount of voltage the cell might gain during relaxation may increase as the rate of the prior charge/discharge increases during the respective charge/discharge cycle itself.

As shown in FIG. 3, at a first time T1, a difference in voltage between the two cells is 0.1 V. As also shown, around the time T1, power from the first cell is used for system load (while power from the second cell is not used), resulting in the dip in voltage for the first cell that is demonstrated by arrow 320. Then for a remainder of the time between time T1 and a later time T2, power from neither cell is used and both cells undergo relaxation. Thus, note that the line 300 from time T1 onwards shows normal relaxation should the first cell not be used to power system components at all, while line 330 between time T1 and T2 illustrates actual relaxation of the first cell after the first cell is used to power system components as just described.

Then at or around time T2, power from the first cell is used for system load again (again while power from the second cell is not used), resulting in another dip in voltage for the first cell that is demonstrated by arrow 340. Then for a remainder of the time between time T2 and a later time T3, power from neither cell is used and both cells undergo additional relaxation. Thus, line 350 between time T2 and T3 illustrates the actual relaxation of the first cell after the first cell is actually used.

Thereafter, at or around time T3, power from the first cell is used for system load yet again (yet again while power from the second cell is not used), resulting in yet another dip in voltage for the first cell that is demonstrated by arrow 360. This dip in voltage may take the first cell down to 4.30 V, at or near the voltage of the second cell also at T3 after the second cell undergoes relaxation from time T0 through time T3.

Thus, as may be appreciated from FIG. 3, power from the first cell is not bled or unnecessarily lost/wasted to bring the first cell into balance with the lower voltage of the second cell. Instead, power from the healthier first cell is used first and gradually to power system components like a CPU, RAM, HDD, and wireless transceiver of a device in which the battery pack is disposed while the unhealthier second cell is allowed to catch up and gain voltage through relaxation, creating a more energy-efficient battery pack. And again note that a gas gauge as described herein may be used to control the discharge circuit of the battery pack to do so, though a CPU or other processor of the device may also be used.

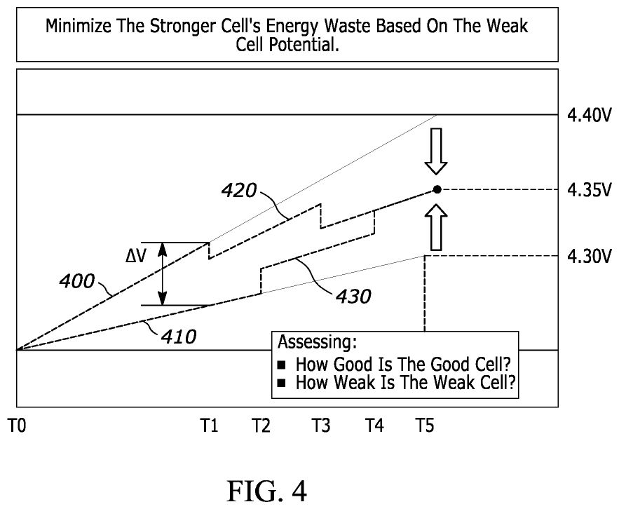

Continuing now in reference to FIG. 4, another example implementation consistent with present principles is shown. According to this second example implementation, a “good” first cell is discharged using system load while a “weak” second cell that has degraded or is unhealthy is charged to increase its voltage and catch up to the voltage of the “good” first cell. This implementation also helps ensure no undue energy waste while the cells are brought into balance (e.g., minimizing the first cell's energy waste based on the second cell's potential).

Also according to this example implementation, the gas gauge processor or other processor may assess how good is the first cell, and how weak or unhealthy is the second cell, by incrementally charging each cell as demonstrated by this figure. This may be done for the gas gauge to determine a feasible, common “max” voltage for the cell group, where this “max” voltage might be below the actual max voltage of the first cell itself but still keeps the first cell in balance with the second cell (e.g., since the second cell might actually not be that unhealthy and the first cell might not actually be that healthy after all). Thus, once this common per-cell “max” voltage is determined for the cells, the gas gauge may subsequently charge the first cell only up to that voltage level during each subsequent charge cycle and then stop, even if charging continues for other cells and even if it's not the true max voltage for the first cell itself.

In terms of incremental charging, incremental charging of each of the first and second cells may be performed so that, for either cell, if the gas gauge puts a small charge into the cell and that cell does not hold the charge, the gas gauge may stop charging the cell up to that voltage amount because the cell is unhealthy enough to not maintain that level of voltage. But if the cell is holding the charge, that is a good sign and the gas gauge may incrementally charge a bit more and then repeat until it finds the current/real-time max potential voltage/storage capacity for that cell (the current max potential voltage where the cell stops taking and/or maintaining charge). Thus, the current voltage limit of each cell's voltage/charge potential may be dynamically discovered in real time and even rediscovered time and again as the cells age and their health and hence max voltage changes. For example, the discovery process may occur at regular, predetermined intervals, such as every twenty-four hours.

Thus, as shown in FIG. 4, line 400 indicates increased voltage that may be experience over time by the first cell due to cell relaxation when not in use at all from time T0 to time T5, while line 410 indicates increased voltage that may be experienced over time by the second cell due to cell relaxation when not in use at all from time T0 to time T5. In contrast, line 420 for the first cell and line 430 for the second cell indicate actual voltage due to charge and discharge (once the lines 420, 430 diverge respectively from lines 400, 410).

As shown in FIG. 4, at time T1, power from the first cell is used for system load (while power from the second cell is not used), resulting in the dip in voltage for the first cell that is shown around time T1. Then for a remainder of the time between time T1 and a later time T2, power from neither cell is used and both cells undergo relaxation. At time T2, the second cell is then charged, resulting in the increase in voltage for the second cell that is illustrated via line 430. Then at a later time T3, the first cell is again used for system load, resulting in another dip in voltage around the time T3 while the second cell continues to undergo relaxation due to non-use. Then between times T3 and T4, each cell undergoes relaxation until, at time T4, the second cell is charged some more, thereby bringing the voltages of the cells into balance even as both cells continue to undergo additional relaxation from time T4 to time T5 (remaining in balance at time T5 as well).

Accordingly, as may be appreciated from FIG. 4, power from the first cell is again not bled or unnecessarily lost/wasted to bring the first cell into balance with the lower voltage of the second cell. Instead, power from the healthier first cell is gradually used to power system components while the second cell is incrementally charged to find its max energy storage potential, creating a more energy-efficient battery pack that is still balanced. And again note that a gas gauge as described herein may be used to control the charge/discharge circuit of the battery pack to do so, though a CPU or other processor may also be used.

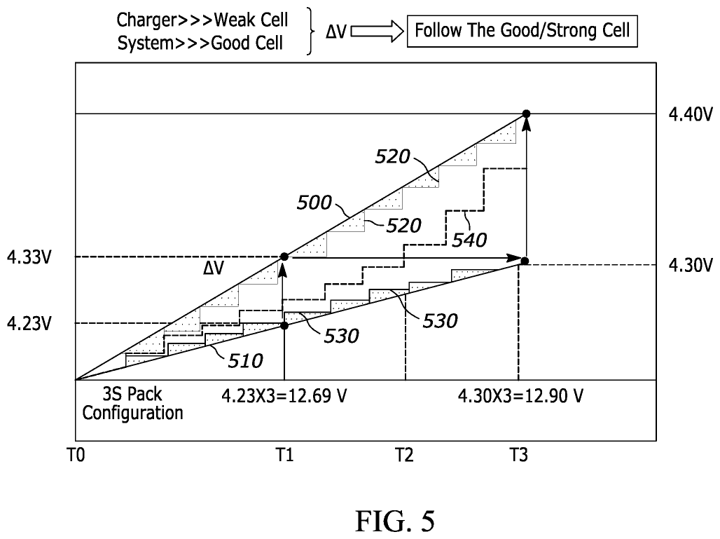

Moving on, reference is now made to FIG. 5. This figure shows yet another example implementation consistent with present principles. According to this example implementation, a “good” first cell and a “weak” second cell are again used for illustration. But here, the gas gauge tries to push the second cell to charge up to the first (good/stronger) cell to catch up to the first cell's voltage and balance the second cell to the first cell's potential. The gas gauge may therefore direct charge power to the second cell first while the first cell is used for system load, giving charge priority to the second cell to try to catch up to the first cell (while also not using the second cell for system load at least until its current voltage level reaches that of the first cell in certain specific examples, and also while not charging the first cell until the second cell catches up in certain specific examples).

Thus, as shown in FIG. 5, line 500 indicates increased voltage that may be experience over time by the first cell due to cell relaxation when not in use from time T0 to time T3, while line 510 indicates increased voltage that may be experienced over time by the second cell due to cell relaxation when not in use from time T0 to time T3. Should a slight draw on the first cell be used for system load from time T0 to T3, steps 520 immediately beneath the line 500 indicate intervals of discharge and charge that the first cell may undergo. Additionally, should a slight draw on the second cell be used for system load from time T0 to T3, steps 530 immediately above the line 510 indicate intervals of charge and discharge that the second cell may undergo.

However, owing to present principles being applied for this third example implementation, additional voltage line 540 indicates actual voltage over time for the second cell. As may also be appreciated from this figure, as time goes on, the gas gauge tests how much it can push the second (unhealthy) cell to catch up to the first (good) cell and, if the second cell continues to accept additional charge, line 540 demonstrates that the gas gauge may incrementally charge the second battery cell by increasingly greater amounts. This is particularly noticeable between times T2 and T3.

Accordingly, as may be appreciated from FIG. 5, power from the first cell is again not bled or unnecessarily lost/wasted to bring the first cell into balance with the lower voltage of the second cell. Instead, the second (weaker) cell is pushed to balance with the first cell rather than wasting energy by draining the first cell to a lower voltage point to balance with the second cell.

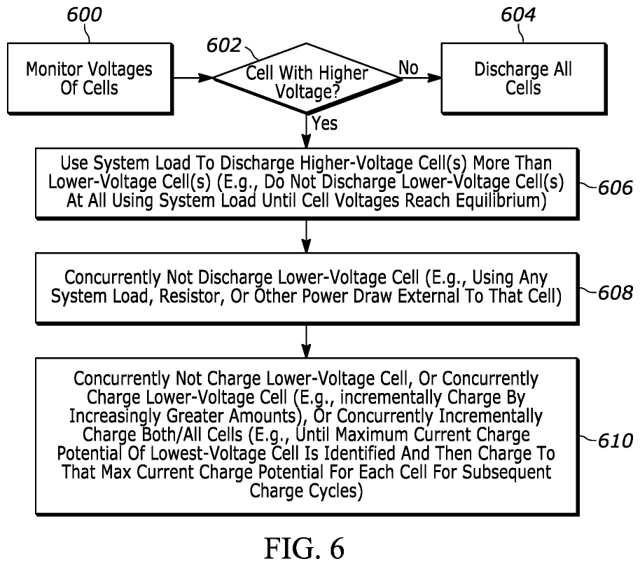

Referring to FIG. 6, it shows example logic that may be executed by a processor consistent with present principles, such as a gas gauge processor, device central processing unit (CPU), etc. Note that while the logic of FIG. 6 is shown in flow chart format, other suitable logic may also be used. Also note that while only two cells will be referenced below for the description of FIG. 6, present principles may be applied for battery packs with more than two cells so that the higher-voltage cells may still be discharged more than the lower/lowest-voltage cell.

Beginning at block 600, the processor may receive input from one or more voltage sensors reading the voltages of the cells within the battery pack so that the processor can monitor the voltages. The logic may then move to decision diamond 602 where the processor may determine whether a first battery cell of the battery pack has a different (e.g., higher) voltage than a second battery cell of the battery pack. Responsive to a negative determination at diamond 602, the logic may proceed to block 604 where the processor may discharge (or charge) the cells together and possibly equally as it otherwise would.

However, responsive to a determination that the first battery cell has a higher voltage than the second battery cell, the logic may instead proceed to block 606. At block 606 the processor may, based on this determination, use system load to discharge the first battery cell more than the second cell. From block 606 the logic may then proceed to block 608.

At block 608 the processor may, based on the affirmative determination at diamond 602 and concurrent with the action of block 606, not discharge the second cell. This may include not discharging the second cell at all with any amount of system load, and also possibly not discharging the second cell at all using a resistor internal to the battery pack (e.g., a resistor 220-226 from FIG. 2) or other power draw external to the cell itself. For reference, this may happen at least until the first and second cell reach equilibrium. From block 608 the logic may then proceed to block 610.

At block 610 the processor may, based on the affirmative determination at diamond 602 and concurrent with the actions of blocks 606 and 608, do one or more of: (A) Concurrently not charge the second (lower-voltage) cell per the description of FIG. 3, or (B) concurrently charge the second (lower-voltage) cell (e.g., incrementally charge it by increasingly greater amounts) per the description of FIG. 5, or (C) concurrently incrementally charge both/all cells (e.g., until a current maximum charge potential of the lowest-voltage capacity cell is identified and then, responsive to the identification, charge to that current max charge potential for each cell but not beyond that maximum current charge potential for subsequent charge cycles for each cell) per the description of FIG. 4.

It may now be appreciated that present principles provide for an improved system/battery pack that conserves power and wastes less energy while also minimizing unnecessary heat generation that can adversely affect other device components, limiting the dominance of the pack's weakest cell in cell balancing. Power from the highest-voltage cell may thus be productively used first while, for example, only not discharging a lowest-voltage cell. In some examples, the weak cell and/or all cells may even be continuously assessed over time (e.g., to assess which cell is weakest and what that cell's current max voltage capacity is).

It is to be understood that whilst present principals have been described with reference to some example embodiments, these are not intended to be limiting, and that various alternative arrangements may be used to implement the subject matter claimed herein. Components included in one embodiment can be used in other embodiments in any appropriate combination. For example, any of the various components described herein and/or depicted in the Figures may be combined, interchanged or excluded from other embodiments.

What is claimed is:

1. A device, comprising:
a processor assembly; and
storage accessible to the processor assembly and comprising instructions executable by the processor assembly to:
determine that a first battery cell of a battery pack has a higher voltage than a second battery cell of the battery pack; and
based on the determination, use system load to discharge the first battery cell more than the second battery cell.

2. The device of claim 1, wherein the instructions are executable to:
based on the determination, use system load to discharge the first battery cell more than the second battery cell and, concurrent with using system load to discharge the first battery cell more than the second battery cell, not discharge the second battery cell.

3. The device of claim 1, wherein the instructions are executable to:
based on the determination, use system load to discharge the first battery cell more than the second battery cell and, concurrent with using system load to discharge the first battery cell more than the second battery cell, neither discharge nor charge the second battery cell.

4. The device of claim 1, wherein the instructions are executable to:
based on the determination, use system load to discharge the first battery cell more than the second battery cell and, concurrent with using system load to discharge the first battery cell more than the second battery cell, not use any system load to discharge the second battery cell.

5. The device of claim 4, wherein the instructions are executable to:
based on the determination, use system load to discharge the first battery cell more than the second battery cell and, concurrent with using system load to discharge the first battery cell more than the second battery cell, neither use any system load to discharge the second battery cell nor charge the second battery cell.

6. The device of claim 4, wherein the instructions are executable to:
based on the determination, use system load to discharge the first battery cell more than the second battery cell and, concurrent with using system load to discharge the first battery cell more than the second battery cell, not use any system load to discharge the second battery cell but charge the second battery cell.

7. The device of claim 6, wherein the instructions are executable to:
based on the determination and concurrent with using system load to discharge the first battery cell more than the second battery cell, incrementally charge the second battery cell by increasingly greater amounts.

8. The device of claim 4, wherein the instructions are executable to:
based on the determination:
use system load to discharge the first battery cell more than the second battery cell; and
incrementally charge both the first battery cell and the second battery cell.

9. The device of claim 1, wherein the processor is established by a gas gauge.

10. The device of claim 1, wherein the first battery cell is a good battery cell, and wherein the second battery cell is a weak battery cell.

11. The device of claim 1, comprising the battery pack.

12. A method, comprising:
determining that a first battery cell of a battery pack has a higher voltage than a second battery cell of the battery pack; and
based on the determination, using system load to discharge the first battery cell more than the second battery cell.

13. The method of claim 12, comprising:
based on the determination, using system load to discharge the first battery cell more than the second battery cell and, concurrent with using system load to discharge the first battery cell more than the second battery cell, neither using any system load to discharge the second battery cell nor charging the second battery cell.

14. The method of claim 12, comprising:
based on the determination, using system load to discharge the first battery cell more than the second battery cell and, concurrent with using system load to discharge the first battery cell more than the second battery cell, not using any system load to discharge the second battery cell but charging the second battery cell.

15. The method of claim 14, comprising:
based on the determination and concurrent with using system load to discharge the first battery cell more than the second battery cell, incrementally charging the second battery cell by increasingly greater amounts.

16. The method of claim 12, comprising:
based on the determination:
using system load to discharge the first battery cell more than the second battery cell; and
incrementally charging both the first battery cell and the second battery cell.

17. At least one computer readable storage medium (CRSM) that is not a transitory signal, the at least one CRSM comprising instructions executable by a processor assembly to:
determine that a first battery cell of a battery pack has a different voltage than a second battery cell of the battery pack; and
based on the determination, use system load to discharge the first battery cell more than the second battery cell.

18. The CRSM of claim 17, wherein the instructions are executable to:
based on the determination, use system load to discharge the first battery cell more than the second battery cell and, concurrent with using system load to discharge the first battery cell more than the second battery cell, neither use any system load to discharge the second battery cell nor charge the second battery cell.

19. The CRSM of claim 17, wherein the instructions are executable to:
based on the determination, use system load to discharge the first battery cell more than the second battery cell and, concurrent with using system load to discharge the first battery cell more than the second battery cell, not use any system load to discharge the second battery cell but charge the second battery cell.

20. The CRSM of claim 17, wherein the instructions are executable to:
based on the determination:
use system load to discharge the first battery cell more than the second battery cell;
incrementally charge both the first battery cell and the second battery cell until a maximum current charge potential of the second battery cell is identified; and
responsive to identifying the maximum current charge potential of the second battery cell, subsequently charge both the first and second battery cells to the maximum current charge potential of the second battery cell but not beyond the maximum current charge potential of the second battery cell.
